(19) United States
(12) Patent Application Publication
(10) Pub. No.: US 2006/0098467 A1
(43) Pub. Date: May 11, 2006

(54) Method and device for controlling voltage

(76) Inventor: Zia Shlaimoun, London (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/519,514

(22) PCT Filed: Jun. 27, 2003
(86) PCT No.: PCT/GB03/02785

§ 371 Date: Sep. 23, 2005

(30) Foreign Application Priority Data
Jun. 27, 2002 (GB) 0214841.9

(51) Int. Cl. H02M 7/515

(52) U.S. Cl. 363/135

(57) ABSTRACT

A voltage control device for connection to an electrical supply having an alternating supply voltage, and relative method for controlling voltage. The device comprising: an input (P1, P2, P3) having an input voltage, said input for connection to the electrical supply; an output (L1, L2, L3) having an output voltage; means for comparing the output voltage with a predetermined voltage (V1, V2, V3) and generating a comparison signal; means to adjust (THY1, THY2, THY3) the output voltage in response to the comparison signal, said means being connected to the input and output; whereby the output voltage is maintained substantially at the predetermined voltage. Preferably, the means to adjust the output voltage comprise means to delay the onset of the rise of output voltage within one half-cycle. More preferably, the means to delay comprises a thyristor module.

THE PRESENT INVENTION relates to a voltage control device for electrical equipment.

Many sites such as commercial premises, e.g. shops and offices, operate a range of electrical equipment such as fridges, cool-rooms, freezers, and computer equipment. Most of this equipment is rated to operate at 230V AC.

However, the electricity supply to such sites can vary dramatically between 200V AC and 250V AC, and in many instances the electricity is supplied towards the higher of these two extremes.

If the electricity is supplied at a voltage higher than the rated voltage of an item of electrical equipment, a number of problems can occur. Firstly, excess electricity is consumed resulting in increased costs. Secondly, additional heat and losses are generated in the equipment, which can lead to premature equipment failure. Thirdly, electrical equipment may be damaged by excess voltage surges.

It can therefore be appreciated that the direct use of such a variable electricity supply has a number of disadvantages.

The invention seeks to provide a solution to this problem.

According to one aspect of the present invention there is provided a voltage control device for connection to an electrical supply having an alternating supply voltage, the device comprising:

an input having an input voltage, said input for connection to the electrical supply;

an output having an output voltage;

means for comparing the output voltage with a predetermined voltage and generating a comparison signal;

means to adjust the output voltage in response to the comparison signal, said means being connected to the input and output;

whereby the output voltage is maintained substantially at the predetermined voltage.

Preferably, the means to adjust the output voltage comprise means to delay the onset of the rise of output voltage within a half-cycle.

Conveniently, the means to adjust the output voltage comprise means to delay the onset of the rise of output voltage within both half-cycles.

Advantageously, the delay in the onset of the rise of output voltage within one half-cycle is controlled independently of the delay in the onset of the rise of output voltage within the other half-cycle.

Preferably, the means to adjust the output voltage comprise a thyristor module.

Conveniently, the thyristor module comprises an antiparallel pair of thyristors.

Advantageously, the means to adjust the output voltage comprise means to reduce the amplitude of the output voltage within a half-cycle.

Preferably, the means to adjust the output voltage comprise means to reduce the amplitude of the output voltage within both half-cycles.

Conveniently, the reduction of the output voltage within one half-cycle is controlled independently of the reduction in the amplitude of the output voltage within the other half-cycle.

Advantageously, the means to reduce the amplitude of the output voltage comprise a variable AC transformer.

Preferably, the device further comprises a bypass switch across the means to adjust the output voltage.

Conveniently, the device further comprises means to vary the predetermined voltage.

Advantageously, the device further comprises a display for displaying set-up parameters and operating information.

Preferably, the device is powered by the input voltage.

Conveniently, the device is for connection to a single phase voltage.

Advantageously, the device is for connection to a multiple phase voltage.

Preferably, the multiple phase supply voltage is a three phase voltage.

According to another aspect of the present invention, there is provided a method of controlling an alternating voltage comprising the steps of:

providing a device having an input which has an input voltage, said input being connected to an electrical supply having an alternating supply voltage;

an output having an output voltage;

comparing the output voltage with a predetermined voltage to generate a comparison signal;

adjusting the output voltage in response to the comparison signal whereby the output voltage is maintained substantially at the predetermined voltage.

Preferably, adjustment of the output voltage comprises delaying the onset of the rise of output voltage within a half-cycle.

Conveniently, the adjustment of the output voltage comprises delaying the onset of the rise of output voltage within both half-cycles.

Advantageously, the delaying of the onset of the rise of output voltage within one half-cycle is controlled independently of the delaying of the onset of the rise of output voltage within the other half-cycle.

Preferably, the delay in onset of rise of output voltage is caused by a thyristor module.

Conveniently, the thyristor module comprises a pair of antiparallel thyristors.

Advantageously, adjustment of the output voltage comprises reduction of the amplitude of the output voltage within a half-cycle.

Preferably, adjustment of the output voltage comprises reduction of the amplitude of the output voltage within both half-cycles.

Conveniently, the reduction of the output voltage within one half-cycle is controlled independently of the reduction in the amplitude of the output voltage within the other half-cycle.

Advantageously, the reduction of the amplitude of the output voltage is caused by a variable AC transformer.

Preferably, the predetermined voltage is varied.

Conveniently, the supply voltage is a single phase voltage.

Advantageously, the supply voltage is a multiple phase voltage.

Preferably, the multiple phase voltage is a three-phase voltage.

Also, there is disclosed a voltage capping device for connection between an AC electrical supply having one or more phases and at least one item of electrical equipment comprising:

a) an electronic switch for each phase of AC electrical supply, in use between the AC voltage supply and the equipment, to vary the voltage delivered in each half-cycle of the AC mains supply,

b) output voltage measuring means to measure the voltage between the switch output and the equipment,

c) comparator means to compare the voltage as measured by the output measuring means with a predetermined voltage value, and

d) control means to control the electronic switch, as dependent on signals received from output measuring means and comparator means, to ensure the voltage delivered to the equipment is substantially equal to said predetermined voltage value.

Preferably the electronic switch consists of a thyristor module that varies the time a voltage is delivered by delaying the onset of each rise in voltage for each half-cycle. Preferably the thyristor module is a pair of thyristors placed back to back.

Preferably a bypass switch is provided across each electronic switch.

Preferably the capping device is powered from the AC electrical supply.

Preferably a display is provided to display set-up parameters and operating information.

Preferably means are provided to vary the predetermined voltage value.

An embodiment of the invention will now be described with reference to the accompanying drawings in which:

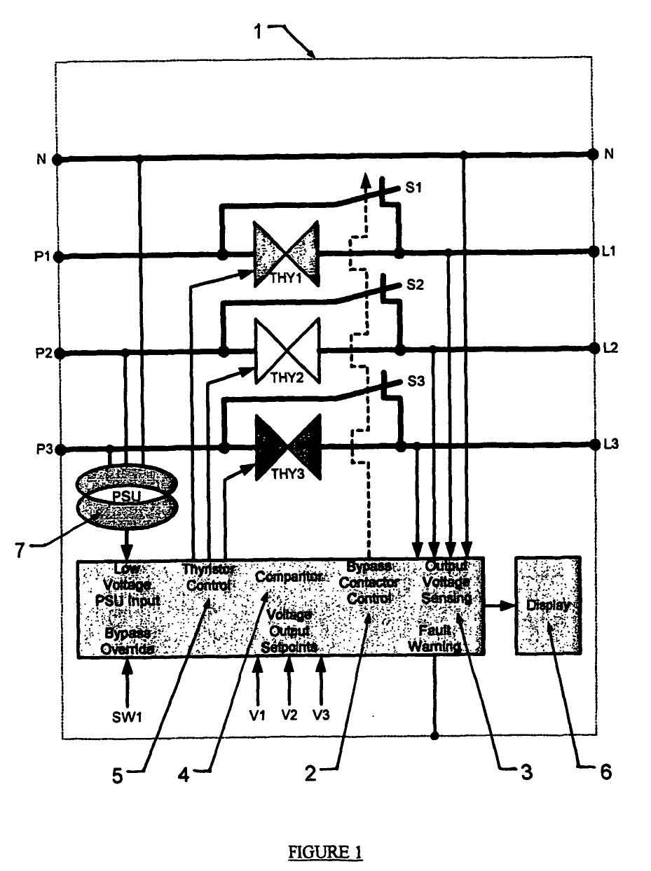

FIG. 1 shows a circuit diagram;

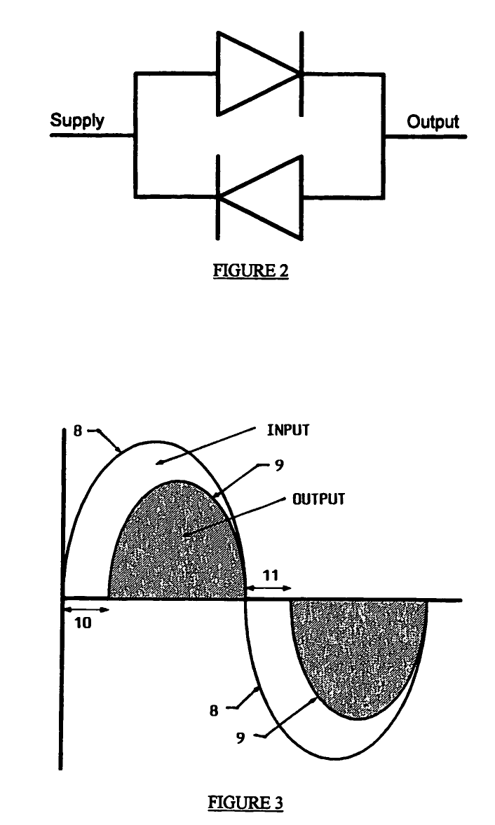

FIG. 2 shows a thyristor module formed from two back to back thyristors;

FIG. 3 shows a graph of one complete AC cycle as altered by a device of the invention; and

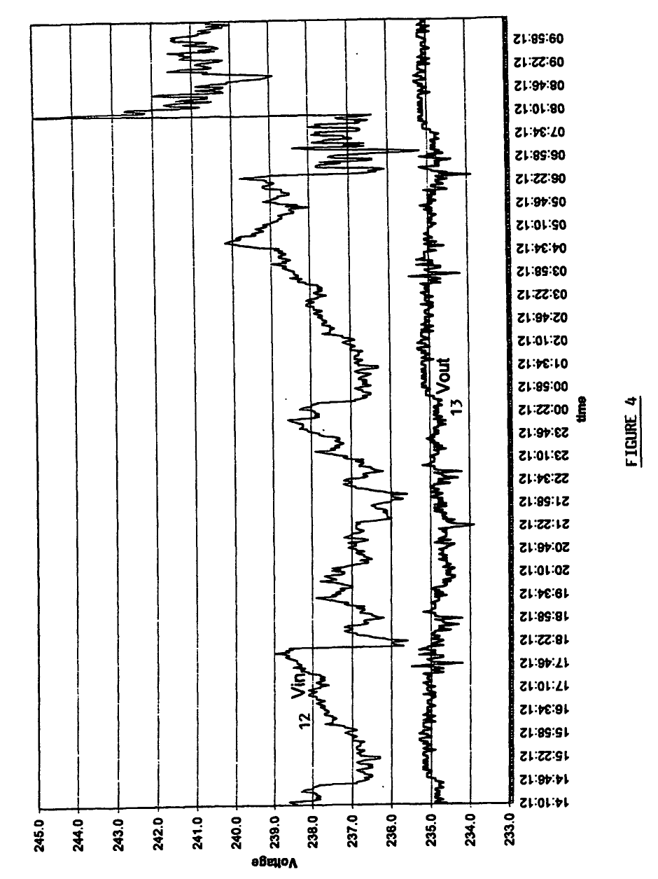

FIG. 4 shows a graph of input voltage and output voltage for a device of the present invention.

Referring to FIG. 1 there is shown a circuit diagram of a voltage capping device 1. The device 1 is connected between an AC electrical supply having three phases P1, P2, P3 and an item of three phase electrical equipment represented by L1, L2, L3.

Device 1 has three electronic switches THY1, THY2, THY3 between each phase P1, P2, P3 of the electrical supply and the equipment L1, L2, L3 respectively to vary the time a voltage is delivered for each half-cycle of the AC mains supply. Switches THY1, THY2, THY3 are each a thyristor module formed by a pair of thyristors placed back to back as shown in FIG. 2. This arrangement is also known as an antiparallel pair of thyristors. Thyristors are also known as silicon-controlled rectifiers, or SCRs.

Each thyristor module varies the time a voltage is delivered by delaying the onset of each rise in voltage for each half-cycle as described below. Switches THY1, THY2, THY3 can be bypassed using bypass switches S1, S2, S3 controlled either by means of a master bypass switch SW1 or automatically in the event of a fault, operating a bypass contactor control circuit 2.

An output voltage sensor 3 provides a measuring means to measure the voltage between each switch output THY1, THY2, THY3 and the equipment L1, L2, L3.

A comparator means is provided by a comparator circuit 4 to compare the voltage as measured by the output voltage sensor with a predetermined voltage value as varied and set by voltage output set-points V1, V2, V3.

A thyristor control means 5 is provided to control the switches THY1, THY2, THY3, as dependent on signals received from output voltage sensor 3 and comparator circuit 4, to ensure the voltage delivered to the equipment L1, L2, L3 is substantially equal to the predetermined voltage value as varied and set by voltage output set-points V1, V2, V3.

A display 6 is provided to display set-up parameters and operating information.

The control device 1 is powered from a power supply unit 7 fed from the AC electrical supply P1, P2, P3.

FIG. 3 is a graph showing voltage over time. Line 8 illustrates the waveform of a normal single phase of AC supply (e.g. from P1). Each thyristor switch THY1, THY2, THY3 is controlled to vary the time a voltage is delivered by delaying the onset of each rise in voltage for each half-cycle, as shown by line 9 so as to reduce the waveform amplitude resulting in a lowering of the effective RMS voltage. Increasing the delay causes the waveform amplitude (and hence RMS voltage) to decrease and reducing the delay causes the waveform amplitude (and hence RMS voltage) to increase.

The control device 1 thus uses its voltage sensor 3 to sense the output voltage of the switches THY1, THY2, THY3, and this voltage value is then adjusted up or down, by delaying the conduction through thyristors THY1, THY2, THY3, depending on whether the voltage value is below or above the predetermined value, as varied and set by voltage output set-points V1, V2, V3.

This is done by setting a threshold value for the input voltage 8 to reach before the thyristor module allows the output voltage 9 to change from zero. This results in a delay 10 in the first half-cycle and a delay 11 in the second half-cycle of the output voltage 9. The delay 10 and the delay 11 could be controlled independently and may not have the same value.

The device thus moderates and controls the variable alternating supply voltage to give a smoothed and consistent output voltage at a predetermined value. If the supply voltage drops below the predetermined voltage value, then the output voltage will drop below the predetermined value accordingly.

A person skilled in the art will appreciate that a similar voltage-controlling effect could be achieved by advancing the return to about zero of the output voltage in each half-cycle. In this embodiment, the device varies the time a voltage is delivered by advancing the return to about zero of the output voltage for each half-cycle. Increasing the advance causes the waveform amplitude (and hence RMS voltage) to decrease and reducing the advance causes the waveform amplitude (and hence RMS voltage) to increase. The output voltage in the half-cycle returns to zero ahead of the input voltage by a certain amount of time.

Also, the output voltage could be adjusted by lowering the amplitude of the output voltage within each half-cycle. This would lead to a lowering of the output RMS voltage. Again, the output voltage in one half-cycle could be controlled independently of the other half-cycle. This could be acheived by using a variable AC transformer.

A combination of these methods of adjusting the output voltage may be used. For example, the output voltage may be delayed in the first half-cycle and advanced in the second half-cycle. Alternatively, the output voltage may be delayed in the first half-cycle and reduced in the second half-cycle.

FIG. 4 shows the result of a trial run of a device according to the invention which delays the rise of the output voltage in each half-cycle. The trial was run over a period of about 20 hours from 14:10 on one day to 10:29 on the following day. The device used contained a Semikron SKKT162 thyristor module and the voltage was measured with a Yokogawa power analysing mter model WT110. The top line 12 shows the supply input voltage over a period of around 20 hours. The bottom line 13 shows the corresponding output voltage produced by a device of the invention. Although the input voltage varies dramatically over this period over almost a 10 volt range, the output voltage remains consistently within about 1 volt of the predetermined voltage value of 235 volts.

It will thus be seen that the control device of the invention can be used to maintain a voltage supply at a constant level at or below a predetermined value.

In practice, the predetermined value can be set at the rated voltage of electrical equipment L1, L2, L3 so that excess electricity is not consumed resulting in increased costs, and so that additional heat and losses are not generated which can lead to premature equipment failure. This also helps to prevent damage to electrical equipment due to excess voltage surges.

The invention may take a form different to that specifically described above. For example instead of one item of three phase electrical equipment L1, L2, L3, the L1, L2, L3 could represent more than one item of three phase equipment or three separate single phase electrical circuits or a combination. Also the control device may be used with single-phase electricity, in which case the control device would have only one electronic switch to control one or more items of single phase electrical equipment.

Further modifications will be apparent to those skilled in the art without departing from the scope of the present invention.

1. A voltage control device for connection to an electrical supply having an alternating supply voltage, the device comprising:
an input having an input voltage, said input for connection to the electrical supply;
an output having an output voltage;
means for comparing the output voltage with a predetermined voltage and generating a comparison signal;
means for adjusting the output voltage in response to the comparison signal, said means being connected to the input and the output;
whereby the output voltage is maintained substantially at the predetermined voltage.

2. A device according to claim 1, wherein the means for adjusting the output voltage comprises means for delaying the onset of a rise of the output voltage within a at least one of the two half-cycles of a waveform of the output voltage.

3. (canceled)

4. A device according to claim 2, wherein the delay in the onset of the rise of the output voltage within one half-cycle is controlled independently of the delay in the onset of the rise of the output voltage within the other half-cycle.

5. A device according to claim 1, wherein the means for adjusting the output voltage comprises a thyristor module.

6. A device according to claim 5, wherein the thyristor module comprises an antiparallel pair of thyristors.

7. A device according to claim 1 wherein the means for adjusting the output voltage comprises means for reducing the amplitude of the output voltage within at least one of the two half-cycles of a waveform of the output voltage.

8. (canceled)

9. A device according to claim 7, wherein the reduction in the amplitude of the output voltage within one half-cycle is controlled independently of the reduction in the amplitude of the output voltage within the other half-cycle.

10. A device according to claim 7, wherein the means for reducing the amplitude of the output voltage comprises a variable AC transformer.

11. A device according to claim 1, further comprising a bypass switch connected across the means for adjusting the output voltage.

12. A device according to claim 1, further comprising means for varying the predetermined voltage.

13. A device according claim 1, further comprising a display for displaying at least one set-up parameter and operating information.

14. A device according to claim 1, wherein the device is powered by the input voltage.

15. A device according to claim 1, wherein the electrical supply having an alternating supply voltage is one of (i) a single phase supply voltage and (ii) a multiple phase supply voltage.

16. (canceled)

17. A device according to claim 15, wherein the multiple phase supply voltage is a three phase voltage.

18. A method of controlling an alternating voltage comprising the steps of:
providing a device having an input which has an input voltage, said input being connected to an electrical supply having an alternating supply voltage and an output having an output voltage;
comparing the output voltage with a predetermined voltage to generate a comparison signal; and
adjusting the output voltage in response to the comparison signal whereby the output voltage is maintained substantially at the predetermined voltage.

19. A method according to claim 18 wherein said step of adjusting the output voltage comprises delaying the onset of a rise of the output voltage within at least one of the two half-cycles of a waveform of the output voltage.

20. (canceled)

21. A method according to claim 19, wherein the delaying of the onset of the rise of the output voltage within one half-cycle is controlled independently of the delaying of the onset of the rise of the output voltage within the other half-cycle.

22. A method according to claim 19, wherein the delay in the onset of the rise of the output voltage is caused by a thyristor module.

23. A method according to claim 22 wherein the thyristor module comprises a pair of antiparallel thyristors.

24. A method according to claim 18 wherein said step of adjusting the output voltage comprises reducing the amplitude of the output voltage within a at least one of the two half-cycles of a waveform of the output voltage.

25. (canceled)

26. A method according to claim 24 wherein the reduction in the amplitude of the output voltage within one half-cycle is controlled independently of the reduction in the amplitude of the output voltage within the other half-cycle.

27. A method according to claim 24, wherein the reduction of the amplitude of the output voltage is caused by a variable AC transformer.

28. A method according to claim 18, wherein the predetermined voltage is varied.

29. A method according to claim 18, wherein the electrical supply having an alternating supply voltage is one of (i) a single phase supply voltage and (ii) a multiple phase supply voltage.

30. (canceled)

31. A method according to claim 29 wherein the multiple phase supply voltage is a three-phase voltage.

32. (canceled)

33. (canceled)

34. (canceled)
